(19) United States
(12) Patent Application Publication
(10) Pub. No.: US 2020/0191235 A1
(43) Pub. Date: Jun. 18, 2020

(54) SHOCK ABSORBER OF GIMBAL, GIMBAL ASSEMBLY, AND MOVABLE PHOTOGRAPHING DEVICE

(71) Applicant: SZ DJI TECHNOLOGY CO., LTD., Shenzhen (CN)

(72) Inventors: Guibin LIANG, Shenzhen (CN); Yongsheng ZHANG, Shenzhen (CN); Song ZHANG, Shenzhen (CN)

(21) Appl. No.: 16/800,627

(22) Filed: Feb. 25, 2020

Related U.S. Application Data
(63) Continuation of application No. PCT/CN2017/099062, filed on Aug. 25, 2017.

(51) Int. Cl. F16F 15/04; F16M 11/12

(52) U.S. Cl. CPC F16F 15/04; G03B 17/561; F16M 11/123

(57) ABSTRACT

A gimbal assembly includes a gimble, a connection shaft and a shock absorber. One end of the connection shaft is connected to the gimbal. The shock absorber includes an inner support member, an outer support member sleeved outside the inner support member, and an elastic member. Two ends of the elastic member are connected to the outer support member and the inner support member, respectively. One of the inner support member and the outer support member is configured to be fixed to a movable device. Another one of the inner support member and the outer support member is configured to be fixed to another end of the connection shaft.

### CROSS-REFERENCE TO RELATED APPLICATION

This application is a continuation of International Application No. PCT/CN2017/099062, filed Aug. 25, 2017, the entire content of which is incorporated herein by reference.

### TECHNICAL FIELD

The present disclosure relates to shock absorbing of a gimbal mounted at a movable device, and in particular relates to a shock absorber of gimbal, a gimbal assembly, and a movable photographing device.

### BACKGROUND

In order to achieve mobile photographing, long-distance photographing, or overhead photographing, a camera may be mounted at a movable device by a gimbal. For example, the camera may be mounted at the bottom of an unmanned aerial vehicle (UAV) by a gimbal. However, since the speed and direction of the movable device always change, accordingly, the existing method of directly mounting the camera on a movable device by a gimbal can easily cause the camera or the gimbal to shake due to inertia, thereby causing these devices or sensors mounted at them not to operate normally or to be damaged.

### SUMMARY

In accordance with the disclosure, there is provided a gimbal assembly. The gimbal assembly includes a gimble, a connection shaft and a shock absorber. One end of the connection shaft is connected to the gimbal. The shock absorber includes an inner support member, an outer support member sleeved outside the inner support member, and an elastic member. Two ends of the elastic member are connected to the outer support member and the inner support member, respectively. One of the inner support member and the outer support member is configured to be fixed to a movable device. Another one of the inner support member and the outer support member is configured to be fixed to another end of the connection shaft.

### BRIEF DESCRIPTION OF THE DRAWINGS

The objectives, features, and advantages of the embodiments of the present disclosure will become easier to understand by referring to the following detailed description of the accompanying drawings. In the drawings, various embodiments of the present disclosure will be described by way of example without limitation.

FIG. 1 is a schematic structural diagram of a shock absorber according to some embodiments of the present disclosure;

FIG. 2 illustrates a top view of the shock absorber of FIG. 1;

FIG. 3 is a cross-sectional diagram of the shock absorber along an A-A line in FIG. 2;

FIG. 4 is a schematic structural diagram of another shock absorber according to some embodiments of the present disclosure;

FIG. 5 illustrates a top view of the shock absorber of FIG. 4;

FIG. 6 is a cross-sectional diagram of the shock absorber along a B-B line in FIG. 5;

FIG. 7 illustrates a top view of another shock absorber according to some embodiments of the present disclosure;

FIG. 8 is a cross-sectional diagram of the shock absorber along a C-C line in FIG. 7;

FIG. 9 is a schematic structural diagram of a gimbal assembly according to some embodiments of the present disclosure;

FIG. 10 illustrates a front view of the gimbal assembly of FIG. 9;

FIG. 11 illustrates a right view of the gimbal assembly of FIG. 9; and

FIG. 12 is a schematic structural diagram of a movable photographing device according to some embodiments of the present disclosure.

Reference Numerals: 110, shock absorber; 1101, outer support member; 11011, snap-fit groove; 1102, inner support member; 11021, shaft hole; 11022, mounting groove; 1103, elastic member; 1104, bolt; 11051, damping rubber layer; 11052, chamber; 11053, rubber ring; 20, camera; 120, gimbal; 1201, support frame; 1202, connection bracket; 130, connection shaft; 140, gland; 30, movable device.

### DETAILED DESCRIPTION OF THE EMBODIMENTS

Below, some embodiments of the present disclosure are described in detail with reference to the drawings. When no conflicts exist, the following embodiments and the features in the embodiments can be combined with each other.

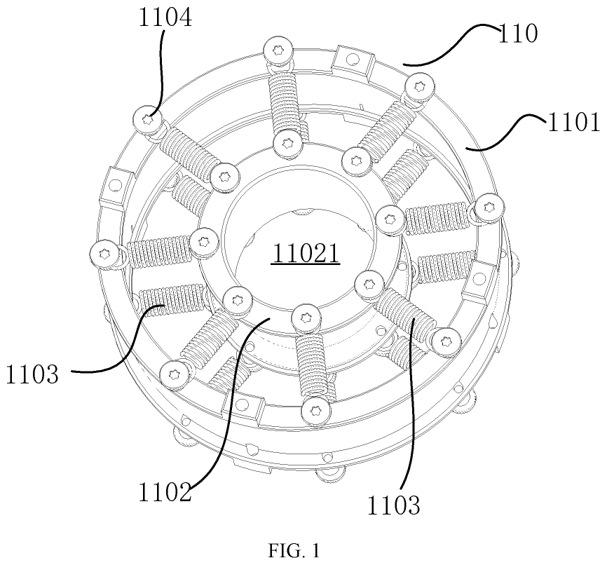

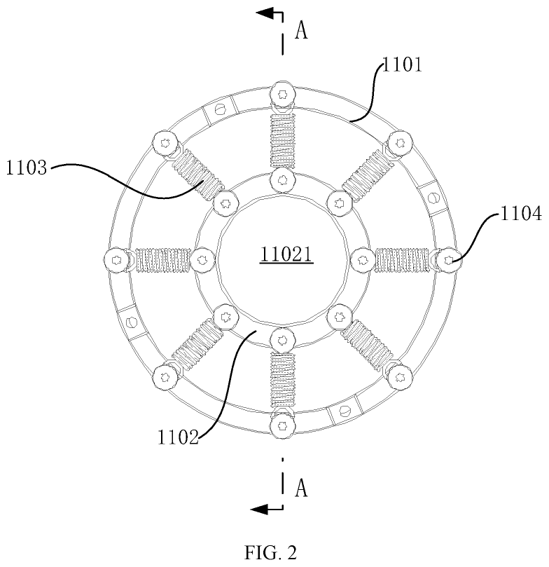

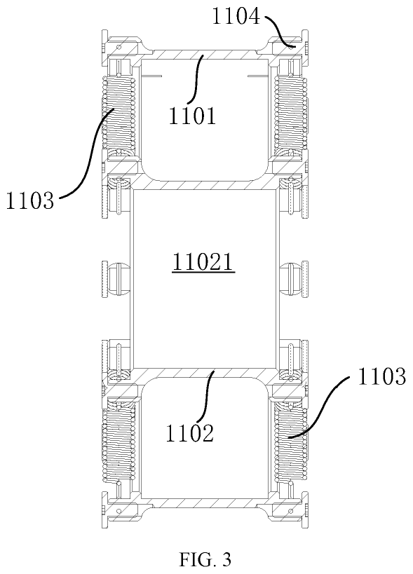

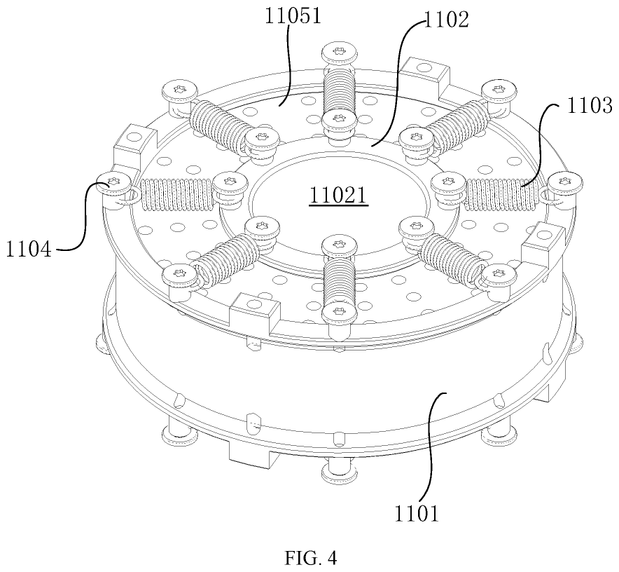

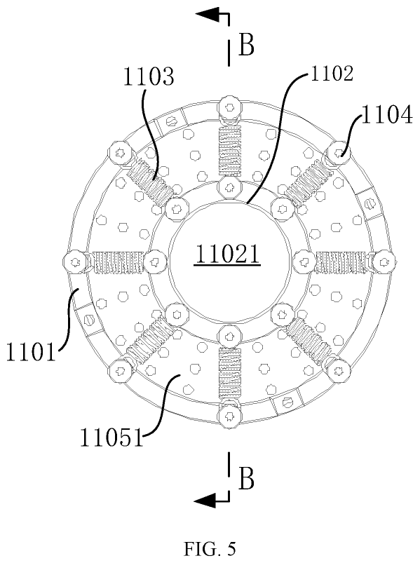

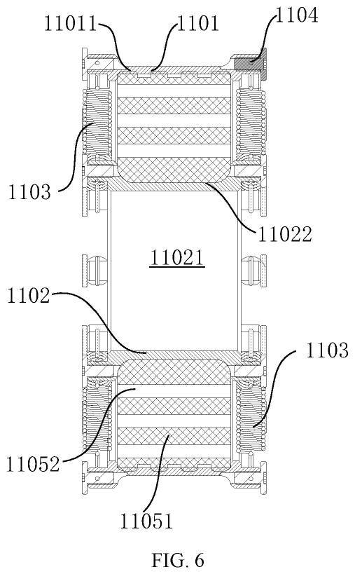

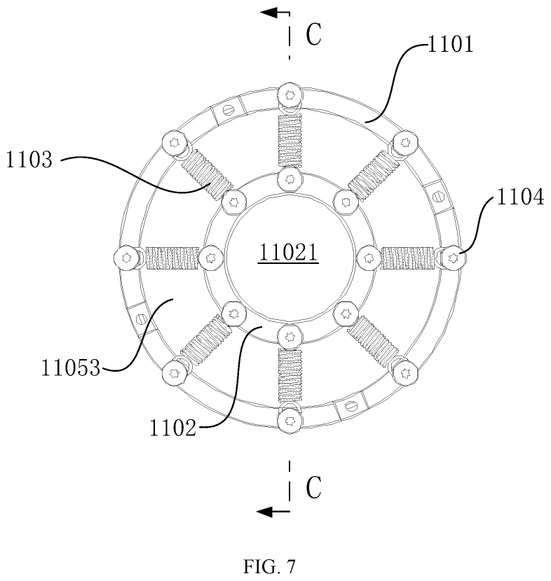

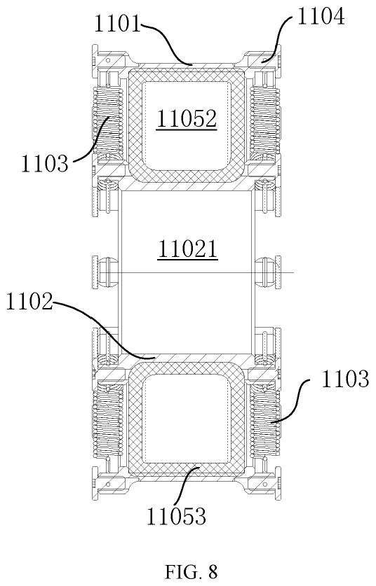

FIG. 1 is a schematic structural diagram of a shock absorber according to some embodiments of the present disclosure; FIG. 2 illustrates a top view of the shock absorber of FIG. 1; FIG. 3 is a cross-sectional diagram of the shock absorber along an A-A line in FIG. 2; FIG. 4 is a schematic structural diagram of another shock absorber according to some embodiments of the present disclosure; FIG. 5 illustrates a top view of the shock absorber of FIG. 4; FIG. 6 is a cross-sectional diagram of the shock absorber along a B-B line in FIG. 5; FIG. 7 illustrates a top view of another shock absorber according to some embodiments of the present disclosure; and FIG. 8 is a cross-sectional diagram of the shock absorber along a C-C line in FIG. 7.

As shown in FIG. 1 to FIG. 8, a shock absorber 110 of this embodiment includes: an outer support member 1101, an inner support member 1102, and a retractable elastic member 1103. The inner support member 1102 is sleeved on an outside of the outer support member 1101, and one of them is configured to be fixed to a movable device 30 and the other is configured to be fixed to the gimbal 120. Two ends of the elastic member 1103 are connected to the inner support member 1102 and an outer support frame 1201, respectively. Since the inner support member 1102 and the outer support member 1101 are respectively fixed to the gimbal 120 and the movable device 30 or to the movable device 30 and the gimbal 120, when the gimbal 120 is shocked, the outer support member 1201 and the inner support member 1102 will move relative to each other under the shock, thereby driving the elastic member 1103 to deform elastically, to buffer the shock of the gimbal 120 and reduce an impact of the shock on the camera 20 or other sensing devices mounted at the gimbal 120, and improve stability and service life of these sensing devices.

Specifically, taking the shock absorber 110 shown in FIG. 1 as an example, the outer support member 1101 may be fixed to the movable device 30, and the inner support member 1102 may be fixed to the gimbal 120. When the movable device 30 moves forward or backward, or during acceleration or deceleration, or turning, due to the inertia effect, the gimbal 120 causes the inner support member 1102 to maintain an original movement trend, so that a relative external disposition between the inner support member 1102 and the outer support member 1101 changes, so to stretch or compress the elastic members 1103 having two ends fixed on the inner support member 1102 and the outer support member 1101, respectively. When the shock absorber 110 in FIG. 1 is accelerated to move to a left by the movable device 30, a left movement speed of the outer support member 1101 is greater than a left movement speed of the inner support member 1102 within a short time after the movable device 30 accelerates, causing the outer support member 1101 and the inner support member 1102 to move relative to each other in a lateral direction (that is, a left to right direction in the drawing). In detail, a left half of the outer support member 1101 moves away from a left half of the inner support member 1102, so that a distance between the left half of the outer support member 1101 and the left half of the inner support member 1102 becomes larger, thereby stretching the elastic member 1103 fixed between the left half of the inner support member 1102 and the left half of the outer support member 1101; and a right half of the outer support member 1101 moves close to a right half of the inner support member 1102, so that a distance between the right half of the outer support member 1101 and the right half of the inner support 1102 becomes smaller, thereby compressing the elastic member 1103 fixed between the outer support member 1101 and the right half of the inner support member 1102. The stretched or compressed elastic member 1103 generates an elastic restoring force, so that the distance between the outer support member 1101 and the inner support member 1102 returns to the initial state, to buffer the shock received by the gimbal 120. Similarly, when the movable device 30 turns, the outer support member 1101 and the inner support member 1102 move relative to each other in a circumferential direction (direction around the outer support member 1101 and the inner support member 1102), or when the movable device 30 jolts, the outer support member 1101 and inner support member 1102 will move relative to each other in an axial direction (direction along an axis of the shock absorber 110), the elastic member 1103 may be stretched or compressed, thereby generating elastic restoring force to restore the inner support member 1102 and outer support member to the initial state, so as counteract the possible shock received by the gimbal 120.

Similarly, when the gimbal 120 shakes during operation, the shock absorber 110 also transmits an energy of the shock to the elastic member 1103 between the outer support member 1101 and the inner support member 1102 through the relative movement between the outer support member 1101 and the inner supporting 1102 as shown above, to buffer the shock of the gimbal 120 and reduce the impact of the shock on the camera 20, etc., mounted at the gimbal 120, thereby improving its stability and service life.

In the shock absorber 110 of this embodiment, by connecting the inner support member 1102 and the outer support member 1101 by the elastic member 1103, the shock absorber 110 connecting the gimbal 120 and the movable device 30 is set. When the gimbal 120 receives a shock, the relative movement of the inner support member 1102 and the outer support member 1101 transmits the shock to the elastic member 1103 and accordingly are buffered by the elastic member 1103, thereby reducing the impact of the shock on the camera 20 or other devices mounted at the gimbal 120, to improve the stability and service life of the gimbal.

Further, referring again to FIGS. 1 to 8, from the perspective of the radial directions of the inner support member 1102, one or more elastic members 1103 may be disposed at the same radial cross-section. When a plurality of elastic members 1103 are disposed at the same radial cross-section, elastic restoring forces may be generated in multiple directions, thereby buffering the shock of the gimbal 120 in multiple directions and improving the shock absorption effect of the shock absorber 110. Optionally, a plurality of elastic members 1103 may be uniformly disposed along a circumferential direction of the inner support member 1102, so that there can be a relatively even elastic restoring force in each direction, and a more even buffering effect can be achieved in multiple directions, and the absorbing effect of the shock absorber 110 can be improved. For example, the number of the elastic members 1103 is two, and the two elastic members 1103 may be disposed at a same diameter direction of the inner support member 1102. Of course, the two elastic members 1103 can also be arbitrarily disposed within an angular range of 180 degrees. For another example, the number of the elastic members 1103 is three, and the three elastic members 1103 may be disposed at positions of three vertices of an equilateral triangle in order to obtain a more even buffering effect. Of course, this embodiment does not exclude that the three elastic members 1103 are disposed at positions of three vertices of a right triangle or another triangle. For another example, the number of the elastic members 1103 is eight, and the eight elastic members 1103 may be evenly disposed along the circumferential direction of the inner support member 1102, as shown in FIG. 1. Of course, the eight elastic members 1103 may also be unevenly disposed in a radial plane of the inner support member 1102.

From the perspective of an axial direction of the inner support member 1102, the elastic members 1103 may be disposed at one or more layers along the axial direction. For example, when one layer of the elastic member 1103 is disposed, the layer of the elastic members 1103 may be disposed at any position such as a top end or a bottom end in the axial direction of the inner support member 1102. Optionally, since the top end of the shock absorber 110 receives relatively strong shock, the elastic members 1103 may be directly disposed at the top end of the shock absorber 110 or near the top end. Of course, it can also be set in a location with strong shock. For another example, a layer of the elastic member 1103 is disposed at each of a top end and a bottom end of the inner support member 1102, as shown in FIGS. 1 to 8. By disposing an elastic layer at each of the top and the bottom of the inner support member 1102, not only can the shock absorption effect be improved, but also it can limit a position of the inner support member 1102 and the outer support member 1101, preventing the inner support member 1102 or the outer support member 1101 from detaching. Of course, this embodiment also does not exclude that two layers of elastic members 1103 are disposed between the top end and the bottom end. For another example, when the number of layers of the elastic member 1103 is more than three, the elastic members 1103 may be all disposed between the top end and the bottom end; or may be disposed in such a manner that one layer is at the top, one layer is at the bottom, and other layers are between the top end and the bottom end.

The above-mentioned elastic member 1103 may be any suitable individual component or combined component. For example, the elastic member 1103 may be a rubber band, and two ends of the rubber band are respectively tied to the outer support member 1101 and the inner support member 1102. Of course, the two ends of the rubber band in this embodiment may also be adhered to the outer support member 1101 and the inner support member 1102, respectively, or connected to the inner support member 1102 and the outer support member 1101 through fixation members. For another example, the elastic member 1103 may be a spring, so that the problem of rubber band aging can be avoided, and by selecting different springs, the shock absorbing effect of the shock absorber 110 can be adjusted as needed. The two ends of the spring can be welded to the outer support member 1101 and the inner support member 1102, respectively, or fixed to the inner support member 1102 and the outer support member 1101 by fixation members. For example, bolt holes can be disposed at top ends of the inner support member 1102 and the outer support member 1101, and the bolts 1104 can be used as fixation members to pass through an upper spring at the top of the inner support member 1102, or a through hole disposed at an end of the rubber band, to be screwed to the bolt hole, as shown in FIG. 1 to FIG. 8. Similarly, a lower spring located at the bottom end of the inner support member 1102 can also be fixed by the bolts 1104 to the bottom ends of the inner support member 1102 and the outer support member 1101.

In this embodiment, the specific structures of the outer support member 1101 and the inner support member 1102 are not limited, and they may be a frame structure or a column structure. For example, a frame structure may be set for both the outer support member 1101 and the inner support member 1102, or one of them is set to be a frame structure to reduce the weight of the shock absorber 110. The specific form of the frame structure is also not limited. In some embodiments, two opposite plates may be disposed to form an open frame structure. In other embodiments, two opposite plates may be disposed and may be connected by another plate to form a semi-closed frame structure. In other embodiments, two sets of opposite plates may also be disposed and connected to form a closed frame structure. In addition, in this embodiment, shapes of the radial cross sections of the outer support member 1101 and the inner supporting 1102 are not limited, and either shape may be circular, oval, polygonal, or any other suitable geometric shape. There is an annular space between the inner support member 1102 and the outer support member 1101, as shown in FIGS. 4 to 8. When the shapes of the radial cross-sections of the outer support member 1101 and the inner support member 1102 are circular, e.g., the outer support member 1101 and the inner support member 1102 are sleeves, then in this scenario, a circular space is formed between the outer support member 1101 and the inner support member 1102.

In some optional embodiments, since the gimbal sways much in the horizontal direction, accordingly, a damping member for buffering a radial movement between the inner support member 1102 and the outer support member 1101 may be installed in the annular space. In this embodiment, the material and specific structure of the damping member are not limited, as long as it can provide damping for the relative movement of the outer support member 1101 and the inner support member 1102. For example, the damping member may be a damping rubber layer 11051 (as shown in FIGS. 4 and 5), a soft bag covered with damping grease, or a rubber ring 11053 (as shown in FIGS. 7 and 8).

Optionally, in order to adjust the damping of the damping member, a chamber may be formed in the damping member, as shown in FIGS. 6 and 8. With different sizes and shapes of the chamber, the damping members can have different damping coefficients, so that the shock absorber 110 has different strengths of damping, so as to adjust the shock absorbing effect of the shock absorber 110. Further, it is also possible to control the damping of the damping member by controlling a number of the chambers, that is, the number of the damping members may be one or more. For example, as shown in FIGS. 4 to 6, a plurality of chambers may be formed in the damping rubber layer 11051 along the radial direction of the inner support member 1102. The plurality of chambers can be evenly disposed in terms of one, two, three or more layers in the annular space. In addition, the chamber formed on the damping rubber layer 11051 may be a through hole that is open at both ends, a hole that is open at one end and closed at one end, or a hole that is closed at both ends. For another example, as shown in FIGS. 7 and 8, a rubber ring 11053 is installed between the inner support member 1102 and the outer support member 1101, and an annular chamber is formed in the rubber ring 11053. Likewise, the annular chamber may be open, semi-closed, or closed.

Optionally, in some embodiments, when a closed chamber is disposed in the damping member, a damping liquid may be filled in the chamber to increase the damping strength of the damping member. The damping liquid may be a medium with different damping coefficients, including but not limited to damping oil or grease.

In addition, it should be noted that when the damping member is disposed in the annular space of the outer support member 1101 and the inner support member 1102, the two layers of elastic members 1103 disposed at the top end and the bottom end of the inner support member 1102 can prevent the damper member from detachment.

Based on the above, the damping of the shock absorber 110 can be adjusted by disposing a chamber in the damping member, and a number of the chambers, a type and capacity of the damping liquid filled in the chamber, etc., can be further adjusted to obtain the shock absorber 110 matching the design requirements, to realize different damping effects.

Further, in order to facilitate mounting of the damping member to the annular space of the inner support member 1102 and the outer support member 1101, as shown in FIGS. 6 and 8, a mounting groove 11022 may be disposed at an outer surface of the inner support member 1102, and an inner surface of the damping member may be sleeved in the mounting groove 11022. In this embodiment, the mounting groove 11022 is not limited to matching the entire inner surface of the damping member, and a part of the inner surface of the damping member may be sleeved in the mounting groove 11022. Specifically, in some embodiments, an annular mounting groove 11022 may be disposed at an outer surface of the inner support member 1102 to increase an area of the damping member sleeved in the mounting groove 11022, thereby improving a connection strength between the damping member and the inner support member 1102. In other embodiments, a plurality of mounting grooves 11022 may be disposed at the outer surface of the inner support member 1102, and the plurality of mounting grooves 11022 may be disposed at intervals along at least one of the radial direction or the axial direction of the inner support 1102. Correspondingly, a plurality of protrusions may be formed on the inner surface of the damping member, and the protrusions are configured to be coupled to the plurality of mounting grooves 11022.

Similarly, as shown in FIG. 6, a snap-fit groove 11011 may be formed on the inner surface of the outer support member 1101, and a protrusion configured to be snapped in the snap-fit groove 11011 may be formed on the outer surface of the damping member. Of course, there may be a plurality of snap-fit grooves 11011 which are spaced apart from each other, or the groove 11011 is annular.

It should be noted that those skilled in the art may choose to use only the mounting groove 11022 (as shown in FIG. 8) or the snap-fit groove 11011, or simultaneously use the mounting groove 11022 and the snap-fit groove 11011 (as shown in FIG. 6), based on the needs of mounting strength.

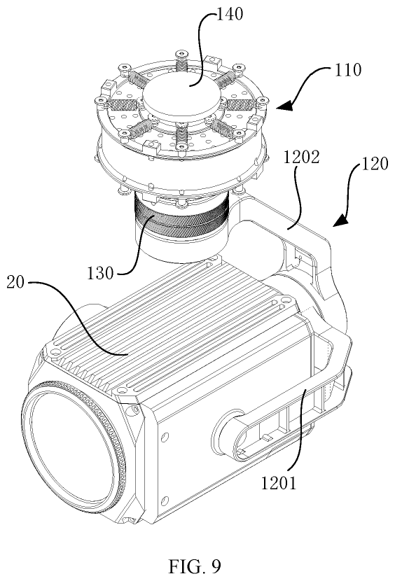

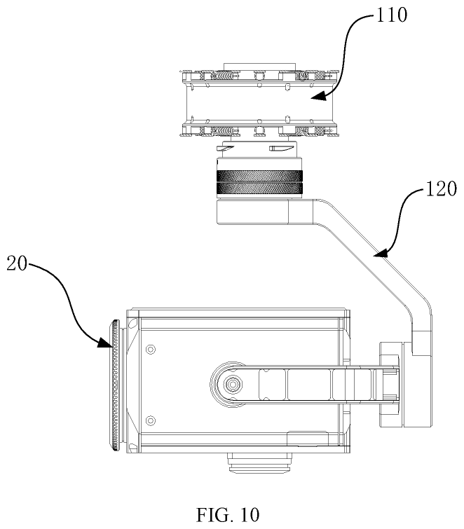

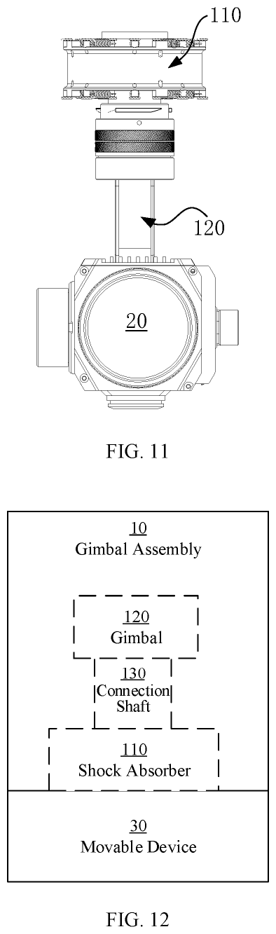

FIG. 9 is a schematic structural diagram of a gimbal assembly according to some embodiments of the present disclosure; FIG. 10 illustrates a front view of the gimbal assembly of FIG. 9; and FIG. 11 illustrates a right view of the gimbal assembly of FIG. 9.

As shown in FIGS. 9 to 11, the present disclosure further provides a gimbal assembly, including: a gimbal 120, a connection shaft 130, and the shock absorber 110 described above. One end of the connection shaft 130 is fixed to the gimbal 120, and the other end of the connection shaft 130 is connected to one of the outer support member 1101 and the inner support member 1102, and the other of the outer support member 1101 and the inner support member 1102 is configured to be connected to the movable device 30.

When the connection shaft 130 is fixed to the inner support member 1102, a solid or hollow inner support member 1102 may be used. For example, when a solid inner support member 1102 is used, a top end or a bottom end of the connection shaft 130 may be fixed to a bottom end or a top end of the solid inner support member 1102 by welding, screwing, or buckling. As another example, when a hollow inner support member 1102 is used, the hollow inner support member 1102 has a hollow shaft hole 11021 for mounting the connection shaft 130. Specifically, in some embodiments, external threads may be disposed at an outer wall of the connection shaft 130, and internal threads may be disposed at an inner wall of the shaft hole 11021, and a top end or a bottom end of the connection shaft 130 may pass through the shaft hole and screwed to the shaft hole 11021. In other embodiments, one end of the connection shaft 130 passes through the shaft hole 11021 and is fixedly connected to a gland 140 disposed at this end, and a fastener passes through a through hole disposed at the gland 140 to be screwed to a bolt hole of the inner support member 1102, as shown in FIGS. 9-11. It should be understood that this embodiment does not exclude the use of fasteners other than the bolts 1104 to fix the gland 140 and the inner support member 1102, such as screws, buckles, and does not exclude a method of directly applying welding to fix the gland 140 and the inner support member 1102. Likewise, when the outer support member 1101 and the connection shaft 130 are fixed, the fixing method and the structures of the connection shaft 130 and the inner support member 1102 can be directly applied or applied with slight modifications, with reference to the above-described fixing method and structures, and details are not described herein again.

The gimbal 120 may be a single-axis gimbal, a two-axis gimbal, or a three-axis gimbal. That is, the gimbal may include one or more rotation mechanisms, one of which is fixed to the connection shaft 130 of the shock absorber 110. For example, FIGS. 9 to 11 illustrate a single-axis gimbal. The rotation mechanism is fixed to the bottom end of the connection shaft 130. The top end of the connection shaft 130 passes through the shaft hole 11021 in a center of the inner support member 1102 and passes through the gland 140, and is fastened to the top end of the inner support member 1102. It should be understood that: the rotation mechanism of the single-axis gimbal can be any one of a yaw axis mechanism, a pitch axis mechanism, and a roll axis mechanism; the two-axis gimbal may be any two of a yaw axis mechanism, a pitch axis mechanism, and a roll axis mechanism; and a three-axis gimbal may simultaneously include a yaw axis mechanism, a pitch axis mechanism, and a roll axis mechanism.

Optionally, the rotation mechanism includes a support frame 1201 for carrying the camera 20 or other sensing devices, and a motor for driving the support frame 1201 to rotate. This embodiment does not limit the specific structural form of the support frame 1201, and those skilled in the art may adopt any suitable structure as the structure of the support frame 1201. For example, as shown in FIGS. 9 to 11, the support frame 1201 may include a frame for mounting the camera 20 and a rotating bracket connected to the frame. The rotating bracket is sleeved on the motor output shaft, so that when the motor drives the output shaft to rotate, the rotating bracket can be driven to rotate, thereby changing an angle of the camera 20. The fixed connection between the gimbal 120 and the connection shaft 130 can be achieved through a connection bracket 1202. One end of the connection bracket 1202 is fixed on the motor or the motor mounting base, and the other end is fixed to the connection shaft 130. In this embodiment, the shock generated by the motor under operation can also be buffered by the shock absorber 110.

FIG. 12 is a schematic structural diagram of a movable photographing device according to some embodiments of the present disclosure. As shown in FIG. 12, the movable photographing device includes a movable device 30 and the above-described gimbal assembly, and the gimbal 120 in the gimbal assembly is configured to carry the camera 20.

Specifically, the movable device 30 may be an unmanned aerial vehicle, a handheld device, or a vehicle. One of the outer support member 1101 and the inner support member 1102 is fixed to the movable device 30, and the other is connected to the connection shaft 130 of the gimbal 120 assembly. In this embodiment, the gimbal 120 assembly may be installed on the top or the bottom of the movable device 30.

For example, when the movable device 30 is a vehicle, the outer support member 1101 or the inner support member 1102 of the shock absorber 110 may be generally fixed on the roof, and the inner support member 1102 or the outer support member 1101 is fixed to the gimbal 120 by the connection shaft 130. When the gimbal 120 receives a shock, its vibration will be buffered by the elastic member 1103 through the movement of the inner support member 1102 relative to the outer support member 1101, thereby ensuring the stability of the gimbal 120 and improving the stability and service life of the camera 20 mounted at the gimbal 120. Of course, if the chassis of the vehicle is relatively far from the ground or the roof is not suitable for mounting the gimbal 120 assembly, the outer support member 1101 or the inner support member 1102 of the shock absorber 110 may be mounted at the bottom of the vehicle. In this embodiment, the vehicle may be any vehicle, such as a family car, a truck, a rail vehicle, or a remotely-controlled gimbal vehicle. When a remotely-controlled gimbal vehicle is used, it is only needed to connect the chassis of the remotely-controlled gimbal vehicle to the gimbal 120 mounted at the remotely-controlled gimbal vehicle via the shock absorber 110.

When the movable device 30 is a UAV, the gimbal 120 assembly may be mounted at the top or the bottom of the UAV. For example, at a fixed connecting member on the top or the bottom of the UAV, the shock absorber 110 in the gimbal 120 assembly is detachably connected to the UAV by the fixed connecting member. Specifically, the outer support member 1101 of the shock absorber 110 may be connected to the fixed connecting member, and the connection shaft 130 of the gimbal 120 assembly may be connected to the inner support member 1102; or, it may also be that the inner support member 1102 of the shock absorber 110 is connected to the fixed connecting member, and the connection shaft 130 of the gimbal 120 assembly is connected to the outer support member 1101.

According to the characteristics of gravity, when the gimbal 120 assembly is disposed at the top of the UAV, the inner support member 1102 or the outer support member 1101 fixed to the connection shaft 130 presses the UAV downward. In this scenario, the shock absorber 110 forms compressive shock absorption. Optionally, in order to prevent the inner support member 1102 or the outer support member 1101 fixed to the connection shaft 130 from colliding with the UAV, an avoidance groove may be formed at the UAV; or, a height of the inner support member 1102 or the outer support member 1101 in the axial direction is set to be smaller than the height of the outer support member 1101 or the inner support member 1102 fixed to the movable device 30.

When the gimbal 120 assembly is disposed at the bottom of the UAV, the inner support member 1102 or the outer support member 1101 fixed to the connection shaft 130 pulls the UAV down. In this scenario, the shock absorber 110 forms a pull-down type shock absorption. In this mounting mode, due to the existence of gravity, the inner support member 1102 or the outer support member 1101 which is generally fixed to the connection shaft 130 will not collide with the UAV. However, it is not excluded to form an avoidance groove on the UAV; or to reasonably adjust the structural settings of the relative heights of the inner support member 1102 and the outer support member 1101.

In this embodiment, the camera 20 mounted at the gimbal 120 may be configured to take images under visible conditions, and/or may be configured to take images under invisible conditions (e.g., infrared photography).

Finally, although the advantages associated with certain embodiments of the technology have been described in the context of these embodiments, other embodiments may also include such advantages, and not all the advantages of the disclosure are described in all the embodiments. The advantages objectively brought by the technical features in the embodiments should be regarded as the advantages of the present disclosure that are different from the existing technologies, and all belong to the scope of the present disclosure.

What is claimed is:

1. A gimbal assembly comprising:
a gimbal;
a connection shaft, one end of the connection shaft being connected to the gimbal; and
a shock absorber including:
an inner support member;
an outer support member sleeved outside the inner support member; and
an elastic member, two ends of the elastic member being connected to the outer support member and the inner support member, respectively;
wherein:
one of the inner support member and the outer support member is configured to be fixed to a movable device; and
another one of the inner support member and the outer support member is configured to be fixed to another end of the connection shaft.

2. The gimbal assembly according to claim 1, wherein the elastic member is one of a plurality of elastic members of the shock absorber, and the plurality of elastic members are located on a same radial cross-section of the inner support member and are disposed along a circumferential direction of the inner support member.

3. The gimbal assembly according to claim 2, wherein the plurality of elastic members are uniformly disposed along the circumferential direction of the inner support member.

4. The gimbal assembly according to claim 2, wherein the plurality of elastic members include two, three, or eight elastic members.

5. The gimbal assembly according to claim 1, wherein:
the elastic member is one of a plurality of elastic members arranged in a plurality of layers disposed along an axial direction of the inner support member.

6. The gimbal assembly according to claim 5, wherein the plurality of layers include two layers disposed at a top end and a bottom end of the inner support member, respectively.

7. The gimbal assembly according to claim 1, wherein the elastic member includes a spring or a rubber band.

8. The gimbal assembly according to claim 1, wherein the shock absorber further includes fixation members fixing the elastic member to the inner support member and the outer support member.

9. The gimbal assembly according to claim 1, wherein the outer support member or the inner support member includes a frame structure.

10. The gimbal assembly according to claim 1, wherein the shock absorber further includes a damping member disposed in an annular space between the inner support member and the outer support member.

11. The gimbal assembly according to claim 10, wherein the damping member includes a chamber.

12. The gimbal assembly according to claim 11, wherein the shock absorber further includes a damping fluid filled in the chamber.

13. The gimbal assembly according to claim 11, wherein the chamber is one of a plurality of chambers of the damping member.

14. The gimbal assembly according to claim 10, wherein the inner support member includes a mounting groove formed at an outer surface of the inner support member, and an inner surface of the damping member is at least partially sleeved in the mounting groove.

15. The gimbal assembly according to claim 14, wherein the mounting groove is annular.

16. The gimbal assembly according to claim 10, wherein:
the outer support member includes a snap-fit groove formed at an inner surface of the outer support member; and
the damping member includes a protrusion formed at an outer surface of the damping member and configured to couple with the snap-fit groove.

17. The gimbal assembly according to claim 10, wherein the damping member includes a damping rubber layer, a soft bag covered with damping grease, or a rubber ring.

18. The gimbal assembly according to claim 1, wherein the gimbal includes one or more rotation mechanisms, one of the one or more rotation mechanisms being connected to the connection shaft of the shock absorber.

19. The gimbal assembly according to claim 18, wherein the one or more rotation mechanisms includes at least one of a yaw axis mechanism, a pitch axis mechanism, or a roll axis mechanism.

20. The gimbal assembly according to claim 18, wherein each of the one or more rotation mechanisms includes:
a support frame; and
a motor configured to drive the support frame to rotate.
